(19) United States
(12) Patent Application Publication
(10) Pub. No.: US 2010/0288038 A1
(43) Pub. Date: Nov. 18, 2010

(54) MEASURING DEVICE FOR DETERMINING THE MATERIAL PARAMETERS OF SOLID MATERIAL SAMPLES

(76) Inventors: Jörg Wallaschek, Paderborn (DE); Ulrich Stolz, Stuttgart (DE); Lutz Bellmann, Gerlingen (DE)

Correspondence Address: KENYON & KENYON LLP, ONE BROADWAY, NEW YORK, NY, 10004, US

(21) Appl. No.: 12/299,392

(22) PCT Filed: Mar. 20, 2007
(86) PCT No.: PCT/EP07/52604

§ 371 Date: Aug. 9, 2010

(30) Foreign Application Priority Data
May 4, 2006 (DE) 10 2006 020 723.8

(51) Int. Cl. G01L 5/28

(52) U.S. Cl. 73/121

(57) ABSTRACT

A measuring unit for determining the material parameters of a solid material sample of a substance includes a sample holder for accommodating the material sample to be tested, an actuator for generating an excitation vibration, a measuring unit and a measured value analysis unit, the actuator including at least one piezoelectric element to be electrically excited, and the actuator and the sample holder having a common longitudinal axis.

### FIELD OF THE INVENTION

The present invention relates to a measuring device for determining the material parameters of solid material samples.

### BACKGROUND INFORMATION

To determine the modulus of elasticity and the damping coefficient of brake linings used in motor vehicles, experimental methods are available, for example carrying out compressibility tests in which the brake linings are subject to quasi-static load and their deformation is measured. In the compressibility test, however, it is not possible to characterize these material parameters under the conditions typical for brake squeaking, since neither the frequencies characteristic for brake squeaking nor the corresponding amplitudes may be generated. However, since the material parameters depend on the brake pressure as well as the frequency and amplitude, the operating conditions typical for brake squeaking must be produced to precisely determine these parameters.

### SUMMARY

An object of the present invention is to provide a measuring device to determine the material parameters of solid material samples of a substance. In particular, it should be possible to determine the material parameters of brake linings for vehicles under the operating conditions typical for brake squeaking.

An example measuring device according to the present invention may be used to determine the material parameters, such as the modulus of elasticity and the damping coefficient, of a solid material sample of, in principle, any substance. In particular, it is possible to test material samples of brake linings used in a brake device of a vehicle, in particular a motor vehicle, under conditions which also occur during real brake squeaking. These conditions are largely determined by the frequency range typical for brake squeaking as well as the prestress under which the material sample is placed. Other areas of application of the measuring device according to the present invention may be the testing of porous materials or plastics which are used, for example, for damping vibrations, or of composite materials which are subject to high-frequency vibrations.

A measuring device having a simple design for determining the material parameters of material samples, for example brake linings, has at least one actuator which includes at least one electrically excitable piezoelectric element, and a sample holder in which the material sample to be tested is accommodated, the actuator and the sample holder being situated coaxially and consequently having a common longitudinal axis. The vibrations generated by the electrically excitable piezoelectric element are transmitted to the sample holder and the material sample accommodated in the sample holder, the sample therefore also being made to vibrate. The vibration is preferably induced in a frequency range which includes frequencies occurring during brake squeaking and advantageously lies in the kilohertz range, for example between 2 kHz and 6 kHz. The vibrations transmitted to the material sample are measured, for example, by piezoelectric sensors, it being possible upon excitation to evaluate the measured values across a predefined frequency spectrum in the form of an electrical or mechanical frequency response which, as an electrical transmission function, represents the ratio between current intensity and excitation voltage or, as a mechanical transmission function, the ratio between displacement velocity and excitation voltage. These frequency responses correlate with the modulus of elasticity and the damping coefficient of the material sample, so that the tested parameters of the material sample are determinable on the basis of the measured values obtained during a vibration excitation via the piezoelectric elements. On the basis of the typical parameters of the frequency curves, such as resonance sharpness and bandwidth, the material parameters of the tested material sample may be determined by analysis from known conditions. The prestress transmitted to the material sample may be determined using suitable devices, for example strain gauges.

Longitudinal vibrations which propagate along the longitudinal axis of the measuring device, i.e., along the actuator axis or the longitudinal axis of the sample holder, are suitably generated in the piezoelectric element. Multiple piezoelectric elements are combinable into a stack to amplify the vibrations. These piezoelectric elements are held together between two clamping members of the actuator and are excited to the desired vibrations by a power electronics system.

To determine the parameters, the entire measuring device is excited in the resonance range in such a way that the excitation frequency range includes the resonance frequency of the measuring device. To enable excitation at the resonance frequency, the geometry of the measuring device as well as the substance must be tuned to the desired operating frequency. However, the actuator and the sample part which includes the sample holder between two sample rods advantageously have the same natural frequency, the basic geometry being specified, for example, using the half-wave synthesis method. The excitation is suitably carried out in such a way that both the one or more piezoelectric elements and the material sample are each located in a vibration node of the induced vibration.

The measuring device is preferably excited to longitudinal vibrations. In principle, however, alternative vibration forms such as shear or bending vibrations may also be used to determine the material parameters of the material sample. Using an appropriately provided setup, the tangential rigidity of the material sample may also be determined.

To obtain an optimum approximation of the actual operating conditions, the material sample is advantageously placed under prestress. For this purpose, the sample holder has a suitable prestressing unit which may be used to place the material sample under the desired prestress. For example, the material sample is accommodated in a sleeve, at each of the two open ends of which a sample rod is held in a non-positive manner, the axial position of the sample rods and thus also the force acting upon the sample being variable. In a particularly preferred embodiment, the diametrically opposed sample rods are connected to the sleeve by a right-handed and a left-handed thread, which makes it possible to apply a voltage to the material sample in a torsion-free manner via the ends of the sample rods. A recess is introducible into the wall of the sleeve, for example in the form of a slot, for the purpose of attaching a measuring unit, in particular a contactless measuring unit such as a laser vibrometer, to the material sample, or a piezoelectric sensor for measuring the vibratory force amplitude. The prestress is measurable via strain gauges.

### BRIEF DESCRIPTION OF THE DRAWINGS

Additional advantages and advantageous embodiments are described below.

FIG. 1 shows a representation of the rod-shaped measuring device having an actuator which contains a stack of a total of six piezoelectric elements for generating vibrations, and having a sample part axially adjacent to the actuator, in which a sample holder, having a material sample for which the material parameters are to be determined, is accommodated.

FIG. 2 shows an enlarged representation of the actuator in the area of the piezoelectric stack.

FIG. 3 shows an enlarged representation of the sample holder in the sample part, including the material sample accommodated therein.

### DETAILED DESCRIPTION OF EXAMPLE EMBODIMENTS

Measuring device 1 illustrated in FIG. 1—also referred to as a converter—is suitable for generating longitudinal vibrations which act upon a material sample 9, for example a brake lining for vehicles, units of measurement such as expansions, stresses or values correlating thereto being measured by measuring units as a response to the vibration excitation and used to determine material parameters of the material sample. Measuring device 1 has a rod-shaped structure and includes an actuator 2 and a sample part 3 situated coaxially to actuator 2 and adjacent to the actuator at one end; actuator 2 and sample part 3 have the same longitudinal axis 12. Actuator 2 includes a piezoelectric stack 6 between two clamping members 4 and 5, of which edge-situated clamping member 4 has a cylindrical design and clamping member 5 facing sample part 3 has a conical design and a diameter which decreases in the direction of sample part 3, the end facing the sample part having the same diameter as an adapter member 7 via which the transition to sample part 3 is produced. Adapter member 7 has the same diameter as the component adjacent to sample part 3. Conical clamping member 5 is used to amplify the amplitude.

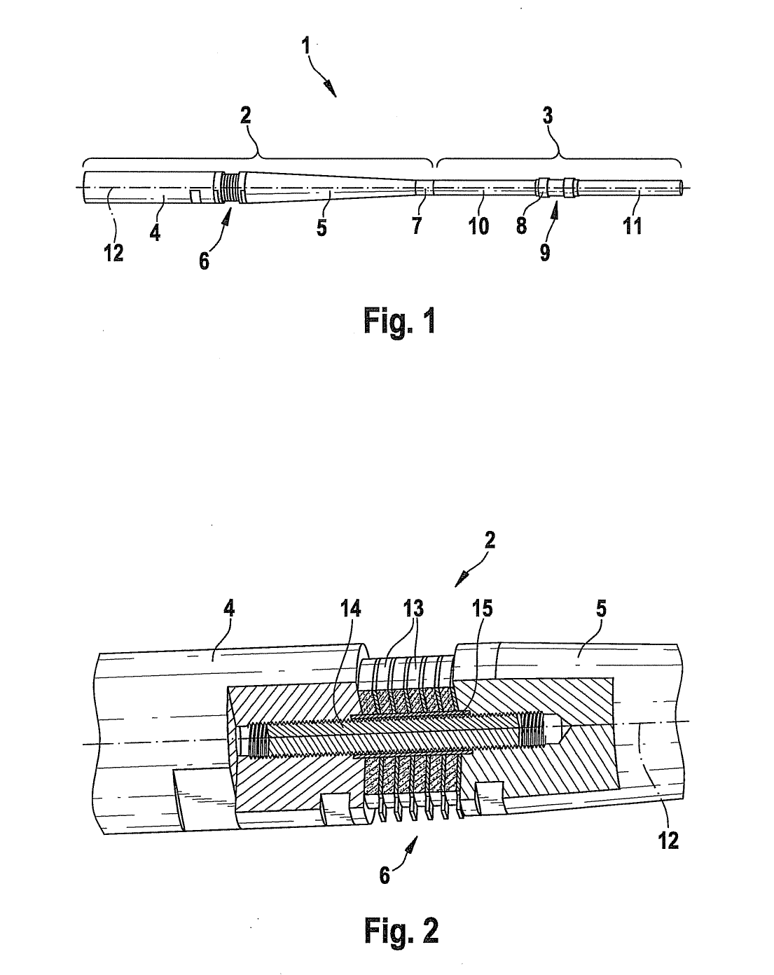

Piezoelectric stack 6, which includes a plurality of individual piezoelectric elements, is situated between clamping members 4 and 5, alternating current being applied to the piezoelectric elements at the desired excitation frequency via a power electronics system, after which the piezoelectric elements expand or contract at the corresponding frequency in the direction of longitudinal axis 12, which triggers the desired longitudinal vibrations. A vibration amplification is achieved by stacking parallel piezoelectric elements 13 (FIG. 2). Alternating voltage is synchronously applied to piezoelectric elements 13 combined in stack 6.

The entire measuring device 1 is suitably mounted in a floating manner to avoid unwanted vibration nodes, which might occur in the case of a fixed mounting. Actuator 2, including the piezoelectric elements, is excited in a frequency range between approximately 2 kHz and approximately 6 kHz; this frequency range includes the frequencies typical for brake squeaking, which lie, for example, in the range of 3.8 kHz.

As illustrated in the enlarged representation of actuator 2 according to FIG. 2, piezoelectric stack 6 includes a plurality of individual piezoelectric elements 13 arranged in parallel which lie directly adjacent to one another. In the exemplary embodiment, a total of six piezoelectric elements are provided, each of which has a plate-shaped design and a central recess through which a connecting screw 14 is inserted, which holds the two clamping members 4 and 5 together on both sides of piezoelectric stack 6 and secures individual piezoelectric elements 13 between clamping members 4 and 5. To avoid unwanted friction against the peripheral surface of screw 14 during the vibratory movement of piezoelectric elements 13, screw 14 is inserted axially through a protective sleeve 15 in the region of piezoelectric stack 6. Individual piezoelectric elements 13 are connected to the power electronics system and supplied by the latter with alternating voltage at the desired frequency.

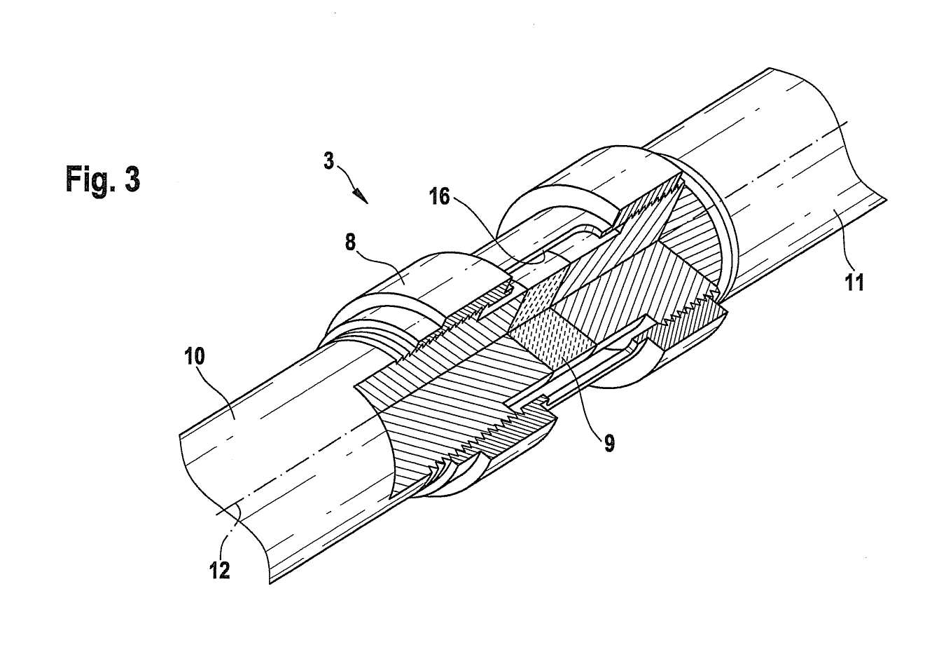

An enlarged and partially cut-away view of sample part 3, including sample holder 8, is illustrated in FIG. 3. Sample holder 8 is designed as a sleeve into the ends of which sample rods 10 and 11 may be screwed. The two sample rods must suitably be connected to sample holder 8 via threads oriented in different directions, i.e., via a right-handed thread and a left-handed thread, which makes it possible to allow plate-shaped material sample 9 accommodated in sample holder 8 to be stressed in a torsion-free manner at both of its ends from the facing ends of sample rods 10 and 11. Sample holder 8 has a greater axial extension than material sample 9, a slot-shaped recess 16 extending in the axial direction being introduced into the wall of sample holder 8 at the height of the material sample so that material sample 9 is exposed in the region of this recess 16, and measurements may be carried out on the material sample. These measurements may be carried out in either a contacting or a contactless manner; for example, strain gauges or contactlessly scanning measuring devices and methods may be used.

To determine the material parameters modulus of elasticity E and damping coefficient tan δ, the measuring device is made to vibrate longitudinally by actuating the piezoelectric elements after applying a prestress acting upon the material sample, expansions, stresses, or measured variables correlating thereto being detected at the height of the material sample. For example, upon excitation over a specified frequency range, electrical frequency response I/U (so-called input admittance) may be determined from the ratio between current I and voltage U, and mechanical frequency response v/U (so-called core admittance) may be determined from the ratio between displacement velocity v at the tip of sample rod 11, measured in the longitudinal direction, and excitation voltage U. The investigated material parameters modulus of elasticity E and damping coefficient tan δ are ascertainable according to fixed relationships.

Modulus of elasticity E is mathematically composed of a real component E′, referred to as the storage component, and an imaginary component E″, referred to as the dissipation component:

E=E′+E″.

Damping coefficient tan δ is determined from the ratio between imaginary component E″ of the modulus of elasticity and real component E′:

tan δ=E″/E′.

As an alternative to the frequency responses, the determination of modulus of elasticity E and damping coefficient tan δ may also be based on the curve of measured values in the time domain.

The measuring device is preferably constructed as a stack-type longitudinal oscillator. In principle, however, shear or bending vibrations may also be considered as the excitation vibrations. In addition, alternative cross-sectional shapes may be used for both the area of piezoelectric elements as well as for the material sample.

The measured values collected in the measuring unit and related to the material sample are supplied to a measured value analysis unit for analyzing the measured values. The material parameters of the material sample are determined in this analysis unit.

1-15. (canceled)

16. A measuring device for determining material parameters of a solid material sample of a substance, comprising:
a sample holder for accommodating a material sample to be tested;
an actuator for generating an excitation vibration acting upon the material sample;
a measuring unit; and
a measured value analysis unit;
wherein the actuator includes at least one piezoelectric element to be electrically excited and the actuator and sample holder have a common longitudinal axis.

17. The measuring device as recited in claim 16, wherein the piezoelectric element generates longitudinal vibrations which propagate along the longitudinal axis of the measuring device.

18. The measuring device as recited in claim 16, wherein a plurality of piezoelectric elements are combined into a stack.

19. The measuring device as recited in claim 16, wherein the measuring device is rod-shaped.

20. The measuring device as recited in claim 16, wherein the actuator and the sample part each have a same natural frequency.

21. The measuring device as recited in claim 16, wherein at least one piezoelectric element is held between two clamping members.

22. The measuring device as recited in claim 16, wherein the sample holder, including the material sample, is accommodated between two sample rods, the sample rods and sample holder forming a sample part situated coaxially in relation to the actuator.

23. The measuring device as recited in claim 22, wherein the sample holder has a prestressing unit via which a prestress is to be applied to the material sample.

24. The measuring device as recited in claim 23, wherein the sample rods are each connected in a non-positive manner to one end of the sample holder, the first sample rod being connected to the sample holder via a right-handed thread and the second sample rod via a left-handed thread.

25. The measuring device as recited in claim 16, wherein a recess is in a wall of the sample holder for attaching a measuring unit.

26. The measuring device as recited in claim 16, wherein vibrations in a frequency range between 2 kHz and 6 kHz, are generatable via the piezoelectric element.

27. The measuring device as recited in claim 16, wherein the material samples are brake linings for vehicles.

28. A method for operating a measuring unit, the measuring unit including a measuring device for determining material parameters of a solid material sample of a substance, the measuring device including a sample holder for accommodating a material sample to be tested, an actuator for generating an excitation vibration acting upon the material sample, a measuring unit, a measured value analysis unit, wherein the actuator includes at least one piezoelectric element to be electrically excited and the actuator and sample holder have a common longitudinal axis, the method comprising:
exciting the at least one piezoelectric element in a range of resonance frequency of the measuring device;
measuring an expansion of the material sample in a direction of vibration or a value correlating thereto; and
determining a modulus of elasticity and a damping coefficient of the material sample from the measured values.

29. The method as recited in claim 28, wherein the measuring device is excited by the piezoelectric element in such a way that the material sample is located in a vibration node.

30. The method as recited in claim 28, wherein the measuring device is excited to longitudinal vibrations.
